(19) United States
(12) Patent Application Publication
(10) Pub. No.: US 2025/0381088 A1
(43) Pub. Date: Dec. 18, 2025

(54) CONTROLLED FORCE SPINAL THERAPY SYSTEMS AND METHODS

(71) Applicants: Matthew John Factor, St. Louis, MO (US); David Joseph Factor, St. Louis, MO (US)

(72) Inventors: Matthew John Factor, St. Louis, MO (US); David Joseph Factor, St. Louis, MO (US)

(21) Appl. No.: 19/236,949

(22) Filed: Jun. 12, 2025

Related U.S. Application Data
(60) Provisional application No. 63/661,282, filed on Jun. 18, 2024.
(60) Provisional application No. 63/718,933, filed on Nov. 11, 2024.

(51) Int. Cl. A61H 1/00

(52) U.S. Cl. CPC A61H 1/008; A61H 2201/0126; A61H 2201/1626; A61H 2201/5005; A61H 2201/5061; A61H 2201/5064

(57) ABSTRACT

A spinal therapy system for improving a patient's spine condition comprises a device having a head adapted for reciprocating movement between extended and retracted positions. The head aligns with a target spinous or transverse process and repetitively applies posterior to anterior force to displace the target process and promote spine rehabilitation, reconditioning, and reshaping. The device includes force sensors for measuring applied force and adjusts head position based on measurements. When programmed force is reached, the head stops and/or reverses to ensure only chosen therapeutic force is applied. A positioning mechanism allows head orientation adjustment through mechanical joints in multiple planes. The system supports various mounting configurations including ceiling-mounted, wall-mounted, table-mounted, floor-mounted, and mobile configurations. Safety features include position sensors, limit switches, and mechanical safety mechanisms. A user interface enables setting treatment parameters including displacement distance, force, frequency, and duration.

### CROSS REFERENCE TO RELATED APPLICATIONS

This application claims the benefit of U.S. Provisional Patent Application 63/661,282, filed on Jun. 18, 2024, and U.S. Provisional Patent Application 63/718,933, filed on Nov. 11, 2024, both incorporated herein by reference.

### STATEMENT REGARDING FEDERALLY SPONSORED RESEARCH AND DEVELOPMENT

Not Applicable.

### FIELD OF THE INVENTION

This invention relates to spinal therapy devices and systems for treating spinal injuries and deformities, and more particularly to devices that apply controlled, repetitive posterior to anterior forces to specific spinal processes to promote rehabilitation, reconditioning, and reshaping of a patient's spine.

### BACKGROUND

Spinal injuries and deformities represent a significant medical challenge affecting millions of people worldwide. The human spine, consisting of 33 vertebrae arranged in cervical, thoracic, lumbar, sacral, and coccygeal regions, serves as the central structural support for the body while protecting the spinal cord. When spinal elements become misaligned due to injury, aging, or degenerative conditions, patients often experience pain, reduced mobility, and diminished quality of life.

Historically, treatment approaches for spinal conditions have evolved from basic manual manipulation techniques to more sophisticated interventions. Physical therapy is a conservative treatment option that can utilize spine manual therapy through practitioner-applied forces that aid recovery. Other conservative treatments include chiropractic and osteopathic care.

As medical technology advanced, more invasive surgical interventions became available for severe spinal conditions. Spinal fusion procedures, disc replacement surgeries, and other surgical techniques were developed to address structural problems within the spine. However, these surgical approaches carry significant risks including infection, nerve damage, failed back surgery syndrome, and lengthy recovery periods. Studies have shown that spinal surgery often fails to achieve the desired outcome of pain reduction and increased mobility, leading many patients to seek alternative treatments.

In response to the limitations of surgery, various non-invasive therapeutic devices have been developed. Mechanical traction devices apply longitudinal forces to decompress spinal segments. Vibration therapy devices deliver oscillating forces to stimulate tissue healing. Electrical stimulation units use electrical impulses to reduce pain and promote muscle function. Ultrasound therapy devices apply acoustic energy to promote tissue repair. More recently, percussive therapy devices, i.e. massage guns, have gained popularity for muscle treatment. However, these percussive devices are fundamentally different from spinal rehabilitation equipment, as they are designed for rapid, high-frequency superficial muscle massage rather than controlled, substantial force application to vertebrae. Such devices typically operate at frequencies of thousands of percussions per minute with minimal force control and are not designed for the precise, sustained forces required for vertebral mobilization. These massage devices lack the ability to apply controlled, repetitive forces with real-time force feedback and cannot provide the specific and substantial posterior to anterior force vectors needed for spinal element alignment.

However, existing non-invasive spinal treatment devices suffer from several significant drawbacks. Current devices lack the ability to apply controlled, repetitive forces specifically targeted to individual spinal processes with real-time force feedback. Most devices cannot provide the precise and significant posterior to anterior force vectors needed to effectively mobilize specific vertebral elements. Additionally, existing devices typically lack the positioning flexibility required to properly align with target spinal processes across different patient anatomies. Many devices also fail to provide adequate force control mechanisms to prevent injury while ensuring therapeutic effectiveness. Unlike percussive massage devices that deliver rapid, uncontrolled impacts, effective spinal rehabilitation requires precise force application with controlled displacement and real-time force monitoring to ensure therapeutic benefit without damage to tissue or deeper anatomical structures.

Current manual treatment approaches place significant physical and time demands on healthcare providers. Spine manual therapy requires skilled practitioners to perform physically demanding, repetitive force applications that can lead to provider fatigue and potential injury. The consistency of treatment is limited by human variability, and the demanding nature of manual therapy restricts the number of patients a provider can effectively treat. This creates challenges in an era where healthcare demands require treating as many patients as possible while maintaining cost-effectiveness and achieving positive outcomes.

The need for improved spinal treatment technology is particularly acute given the ongoing trend toward elevating healthcare standards through technological advancement, a clear pattern observed for more than half a century. Modern healthcare increasingly relies on precision instruments and automated systems to enhance treatment consistency, improve patient outcomes, and reduce provider burden. However, the field of spinal rehabilitation has lagged behind other medical specialties in adopting such technological solutions.

Therefore, there is a need for a device that can apply controlled, repetitive forces specifically to target spinal processes with real-time force monitoring and adjustment capabilities. This device takes into account patient and provider safety and adds elements of precision to medical treatment that aren't currently available. The needed device would provide consistent, repetitive force through load cycles too demanding for providers to perform manually, replacing the physical and time-demanding manual procedures that burden healthcare providers. Such a device would allow widespread mass treatment of patients that is safe and effective, freeing skilled healthcare providers from performing demanding manual procedures and allowing them to treat other patients or provide problem-solving services. Further, the needed device would provide precise positioning and orientation control to properly align with individual vertebral elements. Additionally, such a device would incorporate safety mechanisms to prevent excessive force application while maintaining therapeutic effectiveness. The device would also need to accommodate various mounting configurations for different clinical settings and patient positions. The present invention accomplishes these objectives.

### SUMMARY OF THE INVENTION

The present invention is a spinal therapy system for improving a condition of a patient's spine through controlled, repetitive force application. The system comprises a spinal therapy device having a head adapted for reciprocating movement between extended and retracted positions. The head is alignable with a target spinous or transverse process of a patient's spine and operates to repetitively apply a substantially posterior to anterior force to displace the target process and promote rehabilitation, reconditioning, and reshaping of the patient's spine.

The spinal therapy device includes force sensors for measuring applied force to the patient's spine and adjusts the position of the head based on measurements from these sensors. When the programmed force is reached, the head is reversed to ensure only the chosen therapeutic force is applied.

A positioning mechanism coupled to the spinal therapy device allows adjustment of the device head's orientation relative to the target process through mechanical joints and rigid members that enable alignment of the head with the target process in multiple planes. The device may comprise multiple heads for treating multiple spinal segments simultaneously.

The system includes various mounting configurations including ceiling-mounted, wall-mounted, table-mounted, floor-mounted, and mobile wheel-mounted support systems. A detachable quick-deploy mounting system enables rapid setup and breakdown for medical and military applications. The device may incorporate safety features including position sensors for monitoring head position, limit switches to prevent excessive extension or retraction, and mechanical safety mechanisms to prevent force overload.

A user interface allows setting of treatment parameters including displacement distance, force, frequency, duration, and stored treatment routines. The device is capable of maintaining a programmed force during treatment and allowing users to increase or decrease applied force during the same treatment session.

The present invention addresses the drawbacks of the prior art by providing a spinal therapy device that applies controlled, repetitive forces specifically to target spinal processes with real-time force monitoring and position adjustment capabilities. The device incorporates precise positioning and orientation control mechanisms that properly align with individual vertebral elements across different patient anatomies. The invention preferably includes comprehensive safety mechanisms that prevent excessive force application while maintaining therapeutic effectiveness through integrated force sensors, position sensors, and mechanical failsafe systems.

The device accommodates various mounting configurations including ceiling-mounted, wall-mounted, table-mounted, floor-mounted, and mobile systems for different treatment environments and patient positions. Additionally, the invention provides user-selectable treatment parameters, thereby overcoming the limitations of existing non-invasive spinal treatment approaches. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a schematic view of a spinal therapy system according to a ceiling-mounted embodiment of the present invention;

FIG. 2 is a schematic view of a spinal therapy system according to a table-mounted embodiment of the present invention;

FIG. 3 is a schematic view of a wall-mounted spinal therapy device according to another embodiment of the present invention;

FIG. 4 is a perspective view of a wheel-mounted spinal therapy device according to an embodiment of the present invention;

FIG. 5 is a schematic view of a floor-mounted spinal therapy device positioned below a treatment table according to an embodiment of the present invention;

FIG. 6 is a top view of the treatment table of FIG. 5;

FIG. 7 is a front view of a spinal therapy device with a single head according to an embodiment of the present invention;

FIG. 8 is a front view of a spinal therapy device with dual heads according to another embodiment of the present invention;

FIG. 9 is a block diagram illustrating the control circuit architecture of a spinal therapy device according to an embodiment of the present invention;

FIG. 10 is a left side view of the human spine illustrating the various vertebral segments;

FIG. 11 is a posterior view of the human spine illustrating potential treatment locations for the spinal therapy device; and

FIG. 12 is a side view illustration of the human spine after treatment, demonstrating spinal alignment changes.

### DETAILED DESCRIPTION OF THE PREFERRED EMBODIMENT

Illustrative embodiments of the invention are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list. When the word “each” is used to refer to an element that was previously introduced as being at least one in number, the word “each” does not necessarily imply a plurality of the elements but can also mean a singular element.

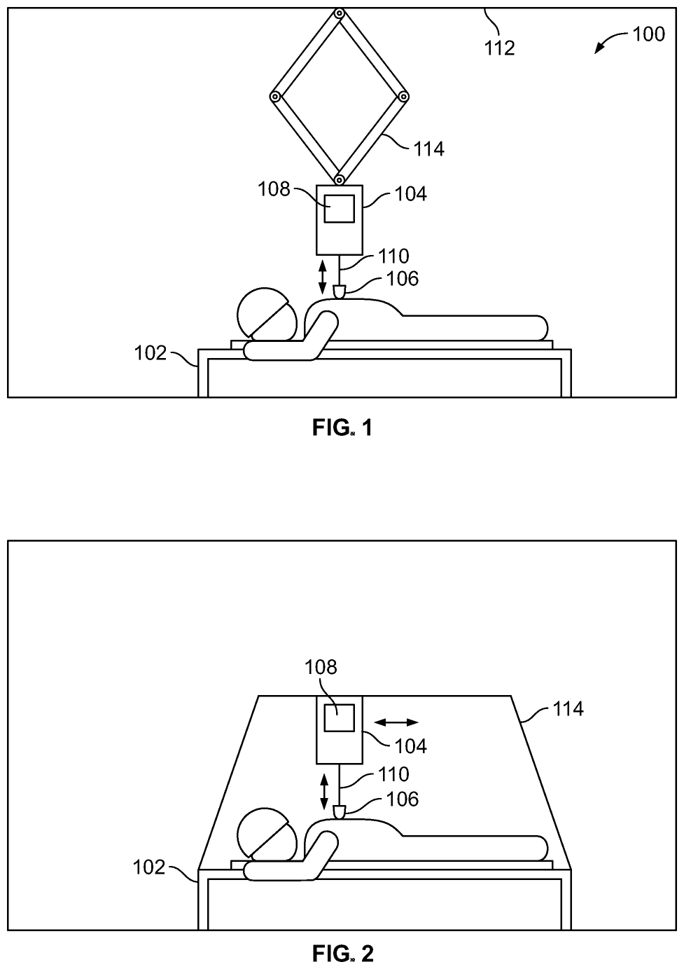

FIGS. 1 and 2 illustrate a system 100 for improving a condition of a patient's spine. The system 100 comprises a spinal therapy device 104 having a head 106 adapted for reciprocating movement between extended and retracted positions. The head 106 of the device 104 is alignable with a target spinous or transverse process of a patient's spine. The spinal therapy device 104 includes one or more force sensors 126 for measuring an applied force to the patient's spine. Such force sensors 126 may comprise button load cells, strain gauges, piezoelectric sensors, capacitive force sensors, or the like. The spinal therapy device 104 is operable to move the head 106 between the extended and retracted positions to repetitively apply a substantially posterior to anterior force to the target spinous or transverse process of the patient's spine to repetitively displace the target spinous or transverse process of the patient's spine and promote rehabilitating, reconditioning, and/or reshaping of the patient's spine. The spinal therapy device 104 is configured to adjust a position of the head 106 based on measurements from the one or more force sensors 126.

In one embodiment, the spinal therapy device 104 further comprises a positioning mechanism 150 coupled to the spinal therapy device 104. The positioning mechanism 150 is configured to allow manual adjustment of an orientation of the head 106 relative to the target spinous or transverse process. The positioning mechanism 150 comprises mechanical joints and rigid members that allow alignment of the head 106 with the target spinous or transverse process in multiple planes. Such a positioning mechanism 150 may comprise gimbal assemblies, ball joints, universal joints, or the like.

In another embodiment, the spinal therapy device 104 comprises multiple heads 106 for treating multiple spinal segments simultaneously, as illustrated in FIG. 8.

As shown in FIG. 1, the system 100 may further comprise a ceiling-mounted support system 112 for the spinal therapy device 104. The ceiling-mounted support system 112 includes an articulating arm 114 for positioning the spinal therapy device 104. Preferably, the support arms 114 provide full freedom of movement (e.g., in all three axes; x, y, and z) to permit moving the spinal therapy device 104 into proper position relative to a patient's spine. The support arms 114 may then be locked in a stationary position to inhibit movement of the spinal therapy device 104 when in use. If necessary, additional bracket(s) or strap(s) 124 may be employed to prevent movement of the spinal therapy device 104 (e.g., to prevent the downward force of the head 106 from deflecting the spinal therapy device 104 upwardly in FIG. 1). Following treatment, the support arms 114 may be unlocked to permit moving the spinal therapy device 104 out of the way so the patient can exit the treatment table 102. Such an articulating arm 114 may comprise telescoping sections, pivoting joints, locking mechanisms 130, or the like, and may be constructed from aluminum, steel, carbon fiber, or the like.

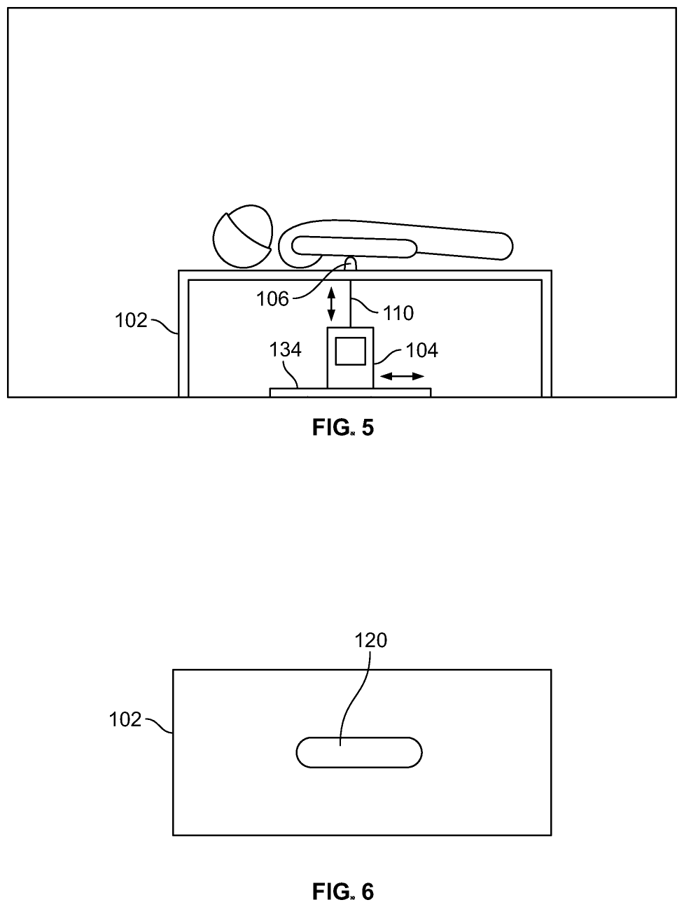

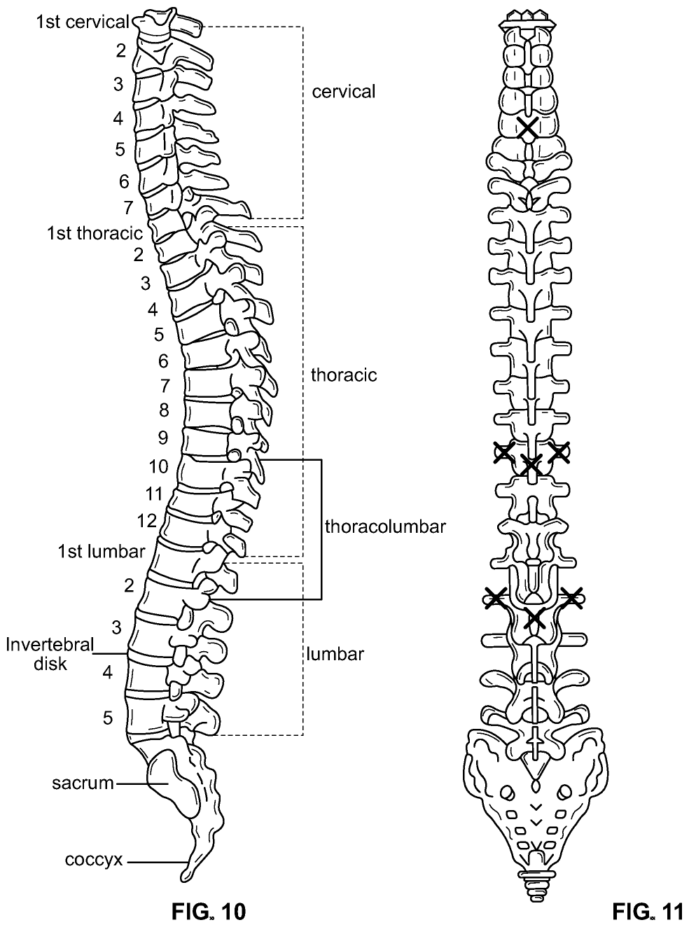

In an alternative embodiment shown in FIG. 5, the system 100 further comprises a treatment table 102 with one or more apertures 120 for the head 106 to extend through. The spinal therapy device 104 is preferably positioned below the table 102. The spinal therapy device 104 may be supported by and/or mounted to the floor, coupled to the table (e.g., as an in-table device), etc. In the specific example shown in FIG. 5, the spinal therapy device 104 is slidably mounted to a support system 134 so the spinal therapy device can be moved into position relative to a target spinous or transverse process. Preferably, the aperture(s) 120 accommodate alignment of the head 106 with each of the spinous and transverse processes discussed below with reference to FIGS. 10 and 11. Such a table 102 may be constructed from wood, metal, composite materials, or the like, and may include padding made from foam, gel, memory foam, or the like.

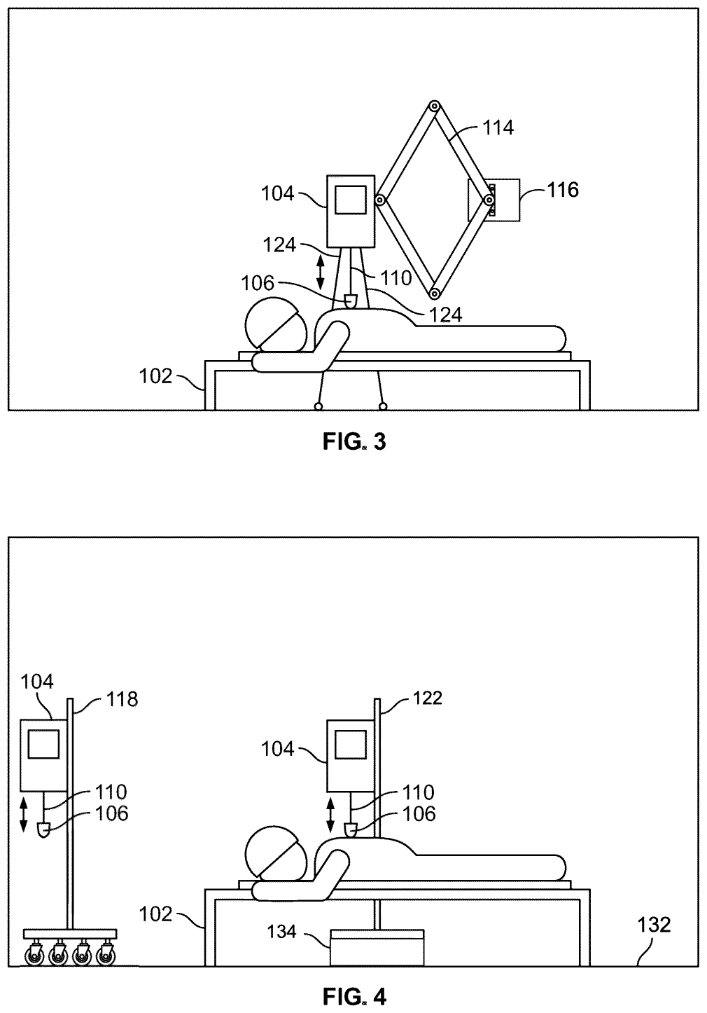

As illustrated in FIG. 3, the system 100 may further comprise a wall-mounted support system 116 for the spinal therapy device 104. The wall-mounted support system 116 includes an articulating arm 114 for positioning the spinal therapy device 104. Such a wall-mounted support system 116 may include mounting brackets, wall anchors, support plates, or the like, constructed from steel, aluminum, or the like.

In another embodiment shown in FIG. 4, the spinal therapy device 104 may also be supported by a floor 132, e.g., via a wheeled floor stand 118 for supporting and transporting the spinal therapy device 104. If necessary, additional strap(s) or brackets) may be employed in the embodiments shown in FIGS. 2-4 to prevent movement of the spinal therapy device 104 during use. Such a mobile stand 118 may include casters, wheels, brakes, height adjustment mechanisms, or the like, and may be constructed from steel, aluminum, or the like.

The system 100 may further comprise a floor-mounted support system 134 for the spinal therapy device 104 optionally positioned above the table. In FIG. 4, the floor-mounted support system 134 replaces the wheel-mount, includes a vertical column 122, and May include an articulating arm (not shown in FIG. 4) for positioning the spinal therapy device 104. Such a vertical column 122 may be adjustable in height and may include locking mechanisms 130, telescoping sections, or the like.

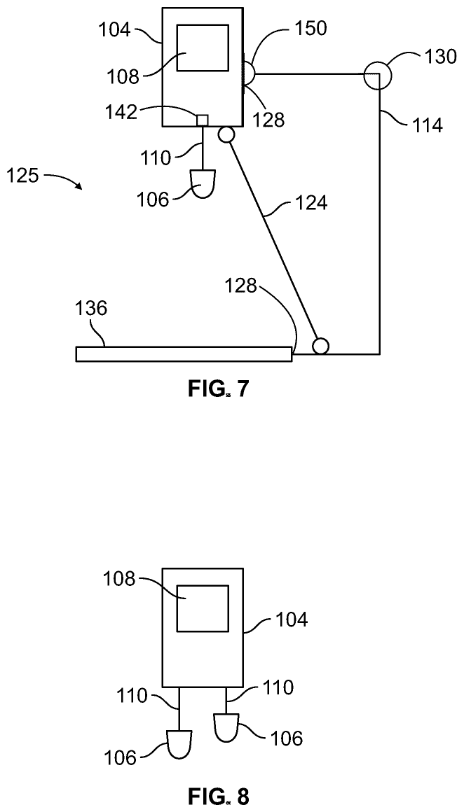

In a specialized embodiment, the system 100 further comprises a detachable quick-deploy mounting system 125 for the spinal therapy device 104. The quick-deploy mounting system 125 comprises a base unit 136 (FIG. 7) configured for rapid attachment to a variety of surfaces. Preferably, a quick-release mechanism 128 securely couples and decouples the spinal therapy device 104 to the base unit 136 via adjustable support arm(s) 114 to facilitate quick deployment, stowage and transport, e.g., for medical and military applications. Adjustable support arms 114 are coupled to the base unit 136, and such support arms 114 allow for rapid positioning of the spinal therapy device 104. The support arm(s) 114 may have an adjustable height. Locking mechanisms 130 on the support arms 114 maintain the spinal therapy device 104 in a desired position. Additionally, the spinal therapy device 104 may be coupled to the table 102, the support arm(s) 114, support base 22 or other suitable structure via one or more brackets or straps 124, as shown for example in FIGS. 3 and 7, to inhibit upward movement or deflection of the spinal therapy device 104 while the head 106 is applying a downward force to the patient's spine.

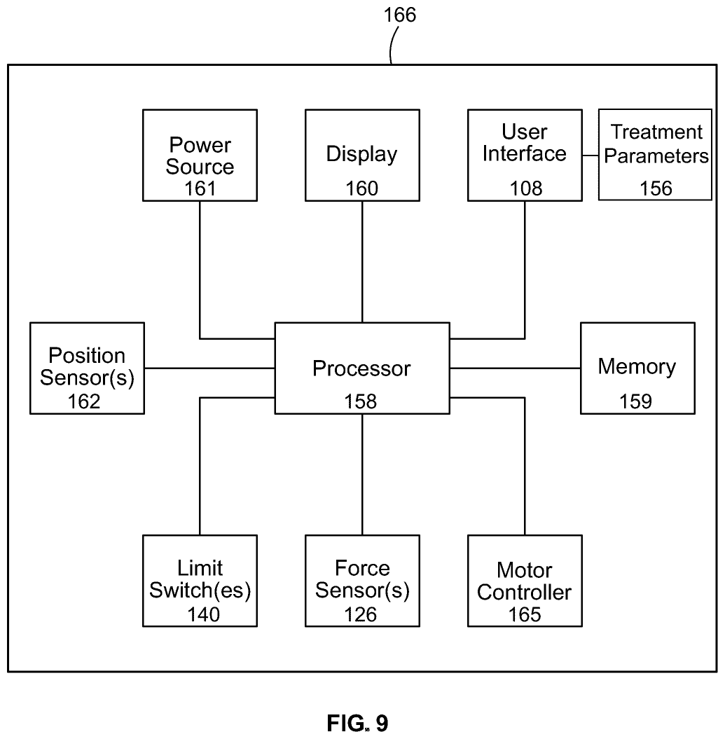

The system 100 may further comprise a position sensor 162 for monitoring the position of the head 106, as shown in the control circuit 166 of FIG. 9. The spinal therapy device 104 utilizes feedback from the position sensor 162 to control an extent of extension and retraction of the head 106, measure and record the displacement of the head 106 that impacts the target spinous or transverse process during treatment, adjust a position of the head 106 based on the applied force measured by the one or more force sensors 126, and ensure the head 106 returns to a predetermined starting position between reciprocating movements. Such a position sensor 162 may comprise potentiometers, encoders, linear variable differential transformers, Hall effect sensors, or the like.

The system 100 preferably further comprises one or more limit switches 140 to prevent excessive extension or retraction of the head 106. Such limit switches 140 may comprise mechanical switches, optical sensors, magnetic sensors, or the like.

A mechanical safety mechanism 142 is preferably configured to prevent force overload, as shown in FIG. 7. The mechanical safety mechanism 142 serves as a failsafe against electrical failure or unexpected patient movement to prevent injury. Such a mechanical safety mechanism 142 may comprise shear pins, breakaway couplings, pressure relief valves, or the like.

As illustrated in FIGS. 1 and 2, the system 100 further comprises a user interface 108 for setting treatment parameters 156. The treatment parameters 156 include at least one of displacement distance, force, frequency, duration, and stored treatment routines. Such a user interface 108 may comprise touchscreens, keyboards, buttons, switches, voice recognition systems, or the like.

The spinal therapy device 104 is preferably configured to maintain a programmed force during treatment, and when the programmed force is reached, the head 106 is reversed to ensure only the chosen therapeutic force is applied.

The head 106 of the spinal therapy device 104 is preferably effective at pushing or moving the targeted spinal element with no skin breakdown and without damage to deeper anatomical structures. The head 106 may employ any suitable shape including round, rectangular, pyramidal, or the like. The head 106 may be constructed from semi-soft to hard materials including rubber, plastic, metal, composites, laminates, gels, high-density foams, fabrics, combinations of these materials, or the like.

The spinal therapy device 104 preferably includes a rod 110 coupled to the head 106 (FIG. 7) and an electric motor (not shown) for moving the head 106 between the extended and retracted positions. Such an electric motor may be a brushless AC motor, brushless DC motor, servo motor, stepper motor, or the like. The rod 110 may be constructed from steel, aluminum, carbon fiber, titanium, or the like.

As shown in FIG. 9, the spinal therapy device 104 includes a control circuit 166 comprising a processor 158 coupled to memory 159, a display 160, the user interface 108, a power source 161, limit switches 140 for the rod 110, position sensors 162 for the rod 110, force sensors 126 for monitoring the force applied to the patient's spine by the head 106, and a motor controller 165. The power source 161 may be an external power source such as from a utility grid, or an internal power source such as a battery, solar power generator, fuel cell, or the like.

FIGS. 10 and 11 illustrate the spinous and transverse processes of a healthy spine, showing the cervical, thoracic, and lumbar vertebrae that may be targeted for treatment. The X's in FIG. 11 designate treatment locations in the cervical, thoracic and lumbar sections for an example patient having a specific spinal deformation. The X's centered on the spine designate spinous processes and the off-center X's designate transverse processes. It should be understood that more or less spinous and transverse processes may be targeted for treatment in any given implementation of these teachings.

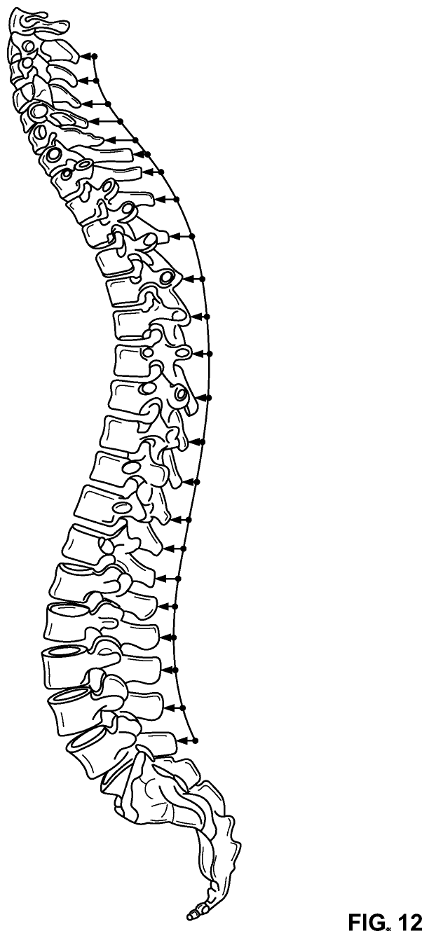

FIG. 12 demonstrates the potential for spinal alignment changes following treatment with the system 100. Additionally, the dots in FIG. 12 indicate the locations of the spinous processes and the unnatural shape of the patient's spine before treatment, and the arrows in FIG. 12 show the extent of reconditioning and reshaping of the patient's spine.

The spinal therapy device 104 is preferably adapted to provide no more than a defined amount of force to the head 106. For example, the head 106 may be adapted to provide no more than 1, 25, 30, 40, 50, 60, 70, 80, 90, 100, 110, 120, or 150 pound-force. The spinal therapy device 104 may be adapted to operate the head 106 at frequencies of 2, 4, 6, 15, 30, 45, 60, 120, 180, 240, 900, 1800, or 3600 times per minute. The device 104 may be adapted to cease moving the head 106 after 1, 2, 5, 10, 15, 30, 45, 60, 75, 90, 105, or 120 minutes. The spinal therapy device 104 may be adapted to move the head 106 no more than 1, 12.7, 19.1, 25.4, 31.8, 38.1, 44.5, 50.8, 57.2, 63.5, 69.9, 76.2, or 80 millimeters. Additionally, or alternatively, the spinal therapy device may be adapted to cycle the head 106 between the extended and retracted positions a defined number of times, depending on the patient's size, spinal condition, treatment regimen, etc. For example, the spinal therapy device may be adapted to cease moving the head 106 after cycling the head between the extended and retracted positions 2, 10, 20, 60, 225, 900, 2025, 3600, 9000, 16200, 25200, or 432000 times.

The method for improving a condition of a patient's spine involves providing a spinal therapy device 104 having a head 106 adapted for reciprocating movement between extended and retracted positions. The method includes aligning the head 106 of the spinal therapy device 104 with a target spinous or transverse process of a patient's spine. The spinal therapy device 104 is operated to move the head 106 between the extended and retracted positions to repetitively apply a substantially posterior to anterior force to the target spinous or transverse process of the patient's spine. An applied force to the patient's spine is measured using one or more force sensors 126 in the spinal therapy device 104.

A position of the head 106 is adjusted based on measurements from the one or more force sensors 126. The target spinous or transverse process of the patient's spine is repetitively displaced to promote rehabilitation, reconditioning, and/or reshaping of the patient's spine. The position of the head 106 is monitored. The extent of extension and retraction of the head 106 is controlled based on position feedback. The displacement of the head 106 that impacts the target spinous or transverse process during treatment is measured and recorded. Treatment parameters 156 are set, wherein the treatment parameters 156 include at least one of displacement distance, force, frequency, duration, and stored treatment routines.

The method may further comprise manually adjusting an orientation of the head 106 relative to the target spinous or transverse process using a positioning mechanism 150 comprising mechanical joints and rigid members. Multiple spinal segments may be treated simultaneously using multiple heads 106 of the spinal therapy device 104. The multiple heads may be operated to move independently of one another, at the same time, according to a defined or random sequence, etc.

The spinal therapy device 104 may be mounted using a support system selected from the group consisting of a ceiling-mounted support system 112, a wall-mounted support system 116, a wheel-mounted mobile stand 118, and a floor-mounted support system 134.

The spinal therapy device 104 may be positioned below a treatment table 102 with one or more apertures 120, and the head 106 extends through the one or more apertures 120 to reach the patient (FIG. 6).

The spinal therapy device 104 may be deployed using a quick-deploy mounting system 125.

A user may increase or decrease the applied force during the same treatment session between operating cycles of the device 104, wherein the programmed force remains constant during each operating cycle and when the programmed force is reached, the head 106 is reversed to ensure only the chosen therapeutic force is applied.

The mechanical safety mechanism 142 may be employed to prevent force overload, with such a mechanical safety mechanism 142 serving as a failsafe against electrical failure or unexpected patient movement to prevent injury. The spinal therapy device 104 is preferably adapted to recreate the natural functional movement of the lumbar spine that can be lost from aging or injury. The treatment requires an effective force to be applied to the damaged spinal element without applying an excessive force that can further damage the spinal element or too low of a force that will be ineffective. The force needs to be able to mobilize the spinal element a specific distance, then allow it to return to a resting state, and then mobilize it again. Such mobilization and return to resting state of the spinal element can be repeated for an extended period of time to increase the effectiveness of the treatment. The treatment can be varied depending on where the patient is in their treatment plan, the effect of prior treatments, and the current condition/damage of the treatment area.

In one example embodiment, the user interface 108 allows an operator to set each parameter within the following ranges: Force of 40 to 100 lbf, Frequency of 6 to 45 times per minute, Duration of 10 to 15 minutes, Displacement Distance of 31.8 to 44.5 mm, and Repetitions of 20 to 1800 times per session. In another example embodiment intended to treat a larger portion of the patient population, the user interface 108 allows an operator to set each parameter within the following ranges: Force of 25 to 110 lbf, Frequency of 2 to 120 times per minute, Duration of 2 to 20 minutes, Displacement Distance of 25.4 to 50.8 mm, and Repetitions of 10 to 2400 times per session.

The treatment regimen can be defined as necessary or appropriate for any given patient and condition. As one example, for a spinal deformation of low severity, a patient may undergo treatment two to three times per week, for five to fifteen minutes per session, over an eight-week period. In contrast, for a spinal deformation of medium severity, a patient may undergo treatment two to three times per week, for five to thirty minutes per session, over a seventeen-week period. For a spinal deformation of high severity, a patient may undergo treatment two to three times per week, for five to forty-five minutes per session, over a twenty-five-week period. It can thus be seen that the length of each session and overall duration of treatment, as well as the number of sessions per week, can be increased or decreased according to the severity of a particular spinal deformation.

The method disclosed herein is preferably well suited for treating spinal injuries conservatively or post-surgically to restore the health of the spine. The method preferably includes conducting a clinical examination of the patient's spine to identify the target spinous or transverse process before aligning and operating the spinal therapy device 104. Alternatively, if the spinal therapy device has only one reciprocating head, the method may include, after repetitively displacing a first target spinous or transverse process, realigning the head with a second target spinous or transverse process, repetitively displacing the second target spinous or transverse process, and further repeating these steps as may be necessary for a given patient or treatment regimen. In a limited number of cases, the treatment period may consist of only one therapy session. In most other cases, however, the duration of treatment may be six to eight weeks or longer, depending on the patient's condition and responsiveness to treatment, and the extent of the desired outcome.

The spinal therapy device 104 employs sophisticated force-threshold control algorithms to ensure safe and effective treatment. The control circuit 166 continuously monitors force measurements from the force sensors 126 and compares these readings to predetermined force thresholds stored in memory 159. When the applied force reaches or approaches the programmed maximum threshold, the processor 158 immediately signals the motor controller 165 to retract the head 106 to its starting position. This force-threshold-based control prevents excessive force application that could cause injury while ensuring adequate therapeutic force is delivered. The control algorithms may incorporate proportional-integral-derivative (PID) control loops, fuzzy logic systems, or adaptive control methods to optimize force application based on patient-specific parameters and real-time feedback.

The system 100 further incorporates adaptive displacement control based on real-time force feedback to optimize treatment effectiveness. As the head 106 extends toward the target spinal process, the force sensors 126 continuously measure the applied force while the position sensor 162 monitors displacement distance. The processor 158 analyzes this data to dynamically adjust the maximum extension distance based on the force profile encountered during each cycle. If higher resistance is detected, indicating tissue stiffness or anatomical variation, the system 100 may reduce the displacement distance to maintain the desired force level. Conversely, if lower resistance is encountered, the system 100 may increase displacement to ensure adequate therapeutic force application. This adaptive approach ensures consistent therapeutic benefit across varying patient anatomies and treatment conditions.

The therapeutic mechanism of the present invention specifically promotes intervertebral disc healing and proper spinal alignment through controlled mobilization of vertebral elements. The repetitive posterior to anterior force application promotes decompression of the spine, which can reduce intradiscal pressure, enhance nutrient diffusion into the intervertebral disc, and facilitate intrinsic healing mechanisms. The controlled displacement of spinous and transverse processes encourages realignment of adjacent vertebrae, reducing abnormal mechanical stress on damaged intervertebral disc structures. The precisely controlled force application supports the formation of organized, healthy scar tissue while limiting the development of restrictive adhesions that can impair spinal mobility. The treatment parameters 156 may be adjusted to accommodate different stages of healing, with lower forces and shorter durations used during acute phases and gradually increased parameters as healing progresses.

The spinal therapy device 104 is fundamentally distinct from handheld percussive massage devices. While percussive devices deliver rapid, high-frequency impacts primarily intended for superficial muscle stimulation, the present invention applies controlled, sustained forces specifically targeted to vertebral structures for spinal realignment. Percussive devices typically operate at frequencies exceeding 1000 impacts per minute with minimal force control, whereas the spinal therapy device 104 operates at much lower frequencies with precise force monitoring and adaptive control. The present invention incorporates sophisticated positioning mechanisms 150 to align perpendicular to specific spinal processes, force sensors 126 for real-time feedback, and safety mechanisms 142 to prevent overload, none of which are present in percussive massage devices. Furthermore, the mounting systems and treatment protocols of the present invention are specifically designed for clinical spinal rehabilitation rather than general muscle massage applications.

For transportation and storage, the system 100 may include a carrying case (not shown) designed to securely hold the spinal therapy device 104 and its components. The carrying case may be padded and compartmentalized to protect the device 104 during transport and may include wheels for easy mobility.

While a particular form of the invention has been illustrated and described, it will be apparent that various modifications can be made without departing from the spirit and scope of the invention. For example, the spinal therapy device 104 could be configured with different head shapes or materials, the force applying electric motor could be replaced with a pneumatic or hydraulic device, the positioning mechanism 150 could employ alternative mechanical joint types, the force sensors 126 could be located at different positions along the rod 110 or within the support structure or on the circuit board, the user interface 108 could be implemented as a separate handheld device or integrated into existing medical equipment, and the mounting systems could be adapted for use with existing medical furniture or specialized treatment environments. Accordingly, it is not intended that the invention be limited, except as by the appended claims.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

What is claimed is:

1. A system for improving a condition of a patient's spine, the system comprising:
a spinal therapy device having a head adapted for reciprocating movement between extended and retracted positions, the head of the device alignable with a target spinous or transverse process of a patient's spine,
wherein the spinal therapy device is operable to move the head between the extended and retracted positions to repetitively apply a substantially posterior to anterior force to the target spinous or transverse process of the patient's spine to repetitively displace the target spinous or transverse process of the patient's spine and promote rehabilitation, reconditioning, and/or reshaping of the patient's spine.

2. The system of claim 1 wherein the spinal therapy device includes one or more force sensors for measuring an applied force to the patient's spine, wherein the spinal therapy device is configured to adjust a position of the head based on measurements from the one or more force sensors.

3. The system of claim 1, wherein the spinal therapy device further comprises:
a positioning mechanism coupled to the spinal therapy device, the positioning mechanism configured to allow adjustment of an orientation of the head relative to the target spinous or transverse process,
wherein the positioning mechanism comprises mechanical joints and rigid members that allow alignment of the head with the target spinous or transverse process in multiple planes.

4. The system of claim 1, wherein the spinal therapy device comprises multiple heads for treating multiple spinal segments simultaneously.

5. The system of claim 1, further comprising a ceiling-mounted support system for the spinal therapy device, the ceiling-mounted support system including an articulating arm for positioning the spinal therapy device.

6. The system of claim 1, further comprising a table with one or more apertures for the head to extend through, wherein the spinal therapy device is mounted below the table.

7. The system of claim 1, further comprising a wall-mounted support system for the spinal therapy device, the wall-mounted support system including an articulating arm for positioning the spinal therapy device.

8. The system of claim 1, further comprising a wheel-mounted mobile stand for supporting and transporting the spinal therapy device.

9. The system of claim 1, further comprising a floor-mounted support system for the spinal therapy device, the floor-mounted support system including a vertical column and an articulating arm for positioning the spinal therapy device.

10. The system of claim 1, further comprising a detachable quick-deploy mounting system for the spinal therapy device, the quick-deploy mounting system comprising:
a base unit configured for rapid attachment to a variety of surfaces; a quick-release mechanism for securely attaching and detaching the spinal therapy device to the base unit;
adjustable support arms connected to the base unit, the support arms allowing for rapid positioning of the spinal therapy device; and
locking mechanisms on the support arms for maintaining the spinal therapy device in a desired position.

11. The system of claim 1, further comprising a position sensor for monitoring the position of the head, wherein the spinal therapy device utilizes feedback from the position sensor to:
control an extent of extension and retraction of the head, measure and record the displacement of the head that impacts the target spinous or transverse process during treatment,
adjust a position of the head based on the applied force measured by the one or more force sensors, and
ensure the head returns to a predetermined starting position between reciprocating movements.

12. The system of claim 1, further comprising a mechanical safety mechanism configured to prevent force overload, the mechanical safety mechanism serving as a failsafe against electrical failure or unexpected patient movement to prevent injury.

13. The system of claim 1, further comprising a user interface for setting treatment parameters, wherein the treatment parameters include at least one of: displacement distance, force, frequency, duration, and stored treatment routines.

14. The system of claim 1, wherein the spinal therapy device is configured to maintain a programmed force during treatment, and when the programmed force is reached, the head is stopped and/or reversed to ensure only the chosen therapeutic force is applied.

15. A method for improving a condition of a patient's spine, the method comprising:
providing a spinal therapy device having a head adapted for reciprocating movement between extended and retracted positions;
aligning the head of the spinal therapy device with a target spinous or transverse process of a patient's spine;
operating the spinal therapy device to move the head between the extended and retracted positions to repetitively apply a substantially posterior to anterior force to the target spinous or transverse process of the patient's spine;
repetitively displacing the target spinous or transverse process of the patient's spine to promote rehabilitation, reconditioning, and/or reshaping of the patient's spine;
monitoring the position of the head;
controlling the extent of extension and retraction of the head based on position feedback;
measuring and recording the displacement of the head that impacts the target spinous or transverse process during treatment; and
setting treatment parameters, wherein the treatment parameters include at least one of: displacement distance, force, frequency, duration, and stored treatment routines.

16. The method of claim 15, further comprising:
measuring an applied force to the patient's spine using one or more force sensors in the spinal therapy device; and
adjusting a position of the head based on measurements from the one or more force sensors.

17. The method of claim 15, further comprising adjusting an orientation of the head relative to the target spinous or transverse process using a positioning mechanism comprising mechanical joints and rigid members.

18. The method of claim 15, further comprising treating multiple spinal segments simultaneously using multiple heads of the spinal therapy device.

19. The method of claim 15, further comprising mounting the spinal therapy device using a support system selected from the group consisting of: a ceiling-mounted support system, a wall-mounted support system, a wheel-mounted mobile stand, and a floor-mounted support system.

20. The method of claim 15, further comprising deploying the spinal therapy device using a quick-deploy mounting system.
